(19) United States
(12) Patent Application Publication
(10) Pub. No.: US 2010/0147172 A1
(43) Pub. Date: Jun. 17, 2010

(54) METHOD AND COMPOSITION FOR REMOVING RESIDUAL INK IMAGE FROM OFFSET PRINTING BLANKET

(75) Inventors: Hugh Daniel McDonald, British Columbia (CA); Hao Wang, Bristish Columbia (CA)

Correspondence Address: MCKEE, VOORHEES & SEASE, P.L.C., 801 GRAND AVENUE, SUITE 3200, DES MOINES, IA, 50309-2721, US

(73) Assignee: ENVIRO IMAGE SOLUTIONS INC, Vancouver, BRITISH COLUMBIA (CA)

(21) Appl. No.: 12/307,464

(22) PCT Filed: Jun. 26, 2007
(86) PCT No.: PCT/CA07/01126

§ 371 Date: Oct. 7, 2009

Related U.S. Application Data
(60) Provisional application No. 60/818,494, filed on Jul. 5, 2006.

(51) Int. Cl. B41F 35/06; C11D 9/08

(52) U.S. Cl. 101/424; 510/171

(57) ABSTRACT

A thickened aqueous cleaning solution for removing residual ink images from the surface of a blanket used in offset lithographic printing which has been subjected to printing using radiation-curable ink. The cleaning solution comprises an alkaline builder, a thickener, a co-solvent, a surfactant and water. A method for removing the residual ink images from the blanket comprises removing the blanket from the offset lithographic printing press, applying a layer of the thickened aqueous cleaning solution to the blanket, rubbing the surface of the blanket, for example with rags or a scouring pad, and removing the soiled cleaning solution.

### FIELD OF THE INVENTION

The present invention pertains to the field of offset lithographic printing and, in particular, to the reconditioning of blankets used with radiation-curable printing inks in such printing.

### BACKGROUND OF THE INVENTION

Offset lithography is a printing process that is well known in the industry. In this process an image is transferred from an inked lithographic master to a rubber or synthetic rubber surface and then onto a substrate rather than directly to the substrate, as in letterpress. The most common offset printing techniques use water and ink.

The offset lithographic process starts with a blank unimaged lithographic precursor in the form of a plate coated with radiation-sensitive media. The lithographic precursor is converted into a lithographic master by a process whereby more hydrophilic areas and less hydrophilic areas are created imagewise on the surface of the plate, typically through photoimaging. This may be done either through a photographic process, or directly via laser beam controlled by computer on the basis of image data provided. The more hydrophilic areas on the lithographic master are receptive to water. Hence, when the lithographic master is brought into contact with a dampening system that applies a water-based fountain solution, the fountain solution will adhere preferentially to the more hydrophilic areas. When an ink is then applied to the lithographic master, the ink will preferentially adhere to the less hydrophilic areas of the lithographic master.

After this imagewise application of the ink, the lithographic master is brought into contact with a blanket and an image is transferred to the blanket. The blanket in turn is brought into contact with a substrate, such as paper, and the image is transferred to the substrate; hence the term “offset”. This printing cycle is then repeated on a continuous basis and at high speed to produce the printed product in volume.

One class of printing inks employed in the printing process, comprises inks that are cured or dried by exposure to radiation. The radiation used for curing these inks has typically been ultraviolet radiation and the inks are commonly known as ultraviolet or UV inks. Such inks are well known in the art (see for example U.S. Pat. No. 4,284,707 Nagasawa et al.) and are commercially available. Other radiation means can also be employed, including electron beam radiation. Radiation-curable ink has a number of advantages when used in offset lithographic printing, including improved printing quality and the fact that the product is dry when it comes off the press.

In order to preserve the quality of the printed product over the course of the printing process, it is important to regularly clean accumulated ink and other impurities off the blanket surface. Blanket washing methods, both manual and automated, are well known in the industry. Traditionally, blanket washing was performed using a combination of highly volatile organic solvents, one example of which is a mix of methyl alcohol, acetone and toluene (called “type wash”). This washing agent is effective in dissolving the ink, does not leave an oily residue and evaporates quickly so that manual drying is unnecessary.

Environmental and safety concerns led to the replacement of this washing agent with combinations of solvents with lower vapor pressures such as ethyl-acetate, n-propyl alcohol and petroleum naphtha (called “blanket wash”). Further developments led to the use of vegetable ester cleaners such as that described in U.S. Pat. No. 5,340,495 (Mulcahy et al.), for removing inks and other contaminants. These compositions are advantageous over the previously-used cleaning agents in that reduced amounts of volatile organic solvents are present. However, the expense of these substances and the extended time and effort required to clean the blanket have confined their application to in-press automatic blanket washing. Heavily soiled blankets are typically still cleaned manually using volatile organic solvents but with lower vapor pressure than that of the original “type wash” cleaning agent.

The blankets employed in printing with conventional inks are typically manufactured from rubber or synthetic rubber compounds or a combination of rubber and synthetic rubber compounds. Some of the ingredients of the radiation-curable ink have adverse effects on the surface of the blanket and cause it to swell. Swelling of the blanket affects the quality of the printing.

The cleaning of blankets that have been employed for several printing jobs using radiation-curable ink, presents a particular challenge. A small part of the radiation-curable ink remains on the blanket, leaving a residual image on the blanket. The residual image shows in the print as a faint ghosted image of the previously printed images in each color printed in subsequent printing runs, thus affecting the quality of the printed product, especially for high-resolution work.

Frequent replacement of the blankets adds significantly to the running costs of a printing press. It is therefore desirable to have a method for successfully refurbishing the blankets, thereby enabling their re-use.

### SUMMARY OF THE INVENTION

The present invention provides a thickened aqueous cleaning solution for removing residual ink images from the surface of a blanket used in offset lithographic printing which has been subjected to printing using radiation-curable ink. The cleaning solution comprises an alkaline builder, a thickener, a co-solvent, a surfactant and water.

The invention also provides a method for removing the residual ink image from the surface of a blanket after use in one or more printing jobs using radiation-curable ink on an offset lithographic printing press. The method comprises contacting the surface of the blanket with a layer of the thickened aqueous cleaning solution for a period of time, agitating the surface, optionally using mild abrasion, and washing the surface, preferably with a non-organic solvent. The method of the invention eliminates residual or ghost ink images caused by the radiation-curable ink process and allows high resolution printing when using the reconditioned blanket.

### DETAILED DESCRIPTION OF THE PREFERRED EMBODIMENTS

The invention provides a composition and method for removing the residual ink image from the surface (i.e. the transferring surface) of a blanket after use in one or more printing jobs using radiation-curable ink on an offset lithographic printing press. Alternatively the composition and method can also be used to remove the residual ink image from the surface of a blanket after use in a printing job using conventional ink.

In this specification, the term “radiation” includes electromagnetic radiation and particle beams. Examples of radiation that can be employed in the method of the present invention include visible light, ultraviolet light, infrared light and electron beams.

In this specification, the term “residual ink image” is used to describe that part of the image remaining on the surface of a blanket after a previous printing job. Removal of the residual ink image means, for the purposes of this invention, removal of the residual ink image to the extent that any subsequently transferred part of the residual image, if any, is not visually observable in the print created using the blanket. Removal of the residual ink image does not mean removal of the residual ink image to an extent that is less than what is required to avoid obtaining a ghost image in the print created using the blanket.

The method of the invention begins with removing from a printing press a blanket, typically manufactured from rubber, which blanket is to be refurbished. In this specification, the term “rubber” is used to denote all natural and synthetic rubber compounds and mixtures of such compounds used in the manufacture of the blankets.

The soiled blanket is laid flat and generally horizontal and its surface is cleaned using a thickened aqueous cleaning solution. The thickened aqueous solution, whose composition is described in detail below, is applied to the affected rubber surface in a uniform layer to avoid getting swollen lumps in the rubber surface. In the preferred embodiment the thickened aqueous solution is applied using a roller, but any other technique to attain a thick uniform layer may be used, such as spraying.

The thickened aqueous cleaning solution has a sufficient viscosity to maintain continuous contact with the surface of the blanket for a period of time, being typically from five to ten minutes. In this period of time, slight bubbling is observed in the layer of thickened aqueous cleaning solution on the surface of the blanket. At the end of the period of time the surface of the layer appears smooth, clear and waxy. If the desired quality of the layer is not achieved after the period of time, then a second layer of the thickened aqueous cleaning solution is optionally applied and left in contact with the blanket for a further period of time, e.g. five to ten minutes.

When the layer of cleaning solution appears smooth, clear and waxy, the surface of the blanket is rubbed using any suitable rubbing means, for example rags or sponges. The rubbing of the blanket surface may optionally be effected with any suitable mild abrasion means including pot scourers, while taking sufficient care not to physically damage the rubber. Tears, holes and abrasions in the rubber surface are to be avoided, as they will adversely affect the quality of the printed product.

After the rubbing step, the resultant soiled thickened aqueous cleaning solution is removed from the blanket surface using a liquid cleaner. To avoid swelling of the rubber, the liquid cleaner is preferably a non-organic solvent, but any other cleaner can be used that is capable of diluting the soiled thickened aqueous cleaning solution to the point where it can be easily absorbed into a rag or sponge.

The thickened aqueous cleaning solution of the invention comprises an alkaline builder, a thickener, a co-solvent, a surfactant and water. Optionally, fragrances and colorants may be added.

Suitable alkaline builders include NaOH, KOH and other bases such as amines. A preferred alkaline builder composition is a solution of 50% NaOH in water. The preferred concentration range of the NaOH solution is 6 to 14 weight % of the cleaning solution (i.e. 3 to 7 wt % of NaOH). A weaker alkaline builder such as monoethanolamine is effective in neutralizing any acidic contaminant and is optionally present in the thickened aqueous cleaning solution. The preferred concentration range of the monoethanolamine is 1 to 5 wt % of the cleaning solution.

The cleaning solution has to have a sufficient viscosity so as to form a layer that can be spread uniformly over the blanket surface to remain in contact with the blanket surface continuously for an extended period of time. Any suitable thickener which does not influence the reactivity of the aqueous cleaning solution, can be used. In a preferred embodiment, industrial grade xanthan gum is used to thicken the aqueous cleaning solution, at a concentration between 0.1 and 1 wt % of the cleaning solution. The viscosity of the cleaning solution is preferably 3 centistokes or higher at 21 degrees C. It is preferably in the range of 3 to 6 centistokes at 21 degrees C. The viscosity is similar to that of house paint.

The thickened aqueous cleaning solution includes a co-solvent, such as a glycol ether or an alcohol. A preferred glycol ether is ethylene glycol monobutyl ether. Other glycol ethers that may be used include propylene glycol monomethyl ether, ethylene glycol monoethyl ether, propylene glycol monobutyl ether, ethylene glycol monopropyl ether and derivatives of these. A preferred alcohol is isopropyl alcohol. The co-solvent is present in the thickened aqueous cleaning solution in a concentration of about 3 to 7 wt % of the cleaning solution. The co-solvent enhances the cleaning properties of the solution by penetrating and softening organic soils. It also contributes to the stability of the product.

The thickened aqueous cleaning solution contains one or more surfactants such as nonylphenol ethoxylate or a phosphate ester. The preferred concentration range of the surfactant is 1 to 5 wt % of the cleaning solution. In one embodiment, a combination of nonylphenol ethoxylate (added in a quantity of 1.3 wt %) and a phosphate ester, alkyl ethoxy phosphate ester (added in a quantity of 1.7 wt %) is used. The surfactant aids in the cleaning properties of the solution by reducing the surface tension of water. A wide range of surfactants can be used, including those that are anionic, cationic, non-ionic and amphoteric.

### EXAMPLE

A thickened aqueous cleaning solution was prepared from the components below:

| Component | Weight (Wt.) % |
|---|---|
| Xanthan gum^{(a)} | 0.3 |
| NaOH (50% in water) | 7.5 |
| Monoethanolamine | 3.6 |
| Ethylene glycol monobutyl ether | 5.5 |
| Nonylphenol ethoxylate^{(b)} | 1.3 |
| Phosphate ester^{(c)} | 1.7 |
| Fragrance | 0.07 |
| Colorant | <0.1 |
| Water | balance |

^{(a)}Kelzan ® T, from CP Kelco, Georgia, USA, a thickening agent.
^{(b)}Tergitol ® NP-9, from Dow Chemical Company, a surfactant.
^{(c)}Interphon AEPE (™) (alkyl ethoxy phosphate ester), from Sialco Materials Ltd., Delta, British Columbia, a surfactant.

The cleaning solution was prepared by the following method. In a mixing vessel, the water, 50% NaOH solution and monoethanolamine were added and mixed together for five to ten minutes to produce a uniform mixture. Then the co-solvent ethylene glycol monobutyl ether and the two surfactants, nonylphenol ethoxylate and the phosphate ester were added. This was mixed for five to ten minutes to produce a uniform mixture. Then the xantham gum was added and the solution was mixed for a further five to ten minutes. The viscosity of the cleaning solution was 3.2 centistokes at 21 degrees C.

Two blankets that had previously been used for printing the cyan and magenta part of an image were used. These two colors tend to be more easily observable in ghosted images. The surface of the blankets was refurbished using the thickened aqueous cleaning solution and the method described above. The reconditioned blankets were employed in a MAN Roland 700 series, 9-color printing press and an image was printed using a 50% screened plate, with a full image from corner to corner and a 10-micron dot. A 10-micron dot is the finest currently used in the industry. The blankets printed an excellent 10-micron screen in both magenta and cyan.

While the invention has been described with reference to specific embodiments thereof, it will be apparent to one skilled in the art that various modifications can be made therein without departing from the scope thereof. The scope of the invention is defined by the claims that follow.

1. A thickened aqueous cleaning solution for removing a residual ink image from a printing blanket of an offset lithographic printing press, said image being formed of radiation-curable ink, comprising:
(a) an alkaline builder that comprises NaOH or KOH;
(b) an amine;
(c) a thickener;
(d) a co-solvent that comprises an alcohol or glycol ether;
(e) a surfactant; and
(f) water.

2. A cleaning solution according to claim 1 wherein said alkaline builder comprises a 50% solution of NaOH in water.

3. A cleaning solution according to claim 2 wherein said 50% solution of NaOH comprises 6-14 weight % of said cleaning solution.

4. A cleaning solution according to claim 1 wherein said amine is monoethanolamine.

5. A cleaning solution according to claim 1 wherein said cleaning solution comprises 1-5 weight % of said amine.

6. A cleaning solution according to claim 1 wherein said thickener comprises xanthan gum.

7. A cleaning solution according to claim 1 wherein said cleaning solution comprises 0.1-1 weight % of said thickener.

8. A cleaning solution according to claim 1 wherein said glycol ether is ethylene glycol monobutyl ether.

9. A cleaning solution according to claim 1 wherein said glycol ether is one of propylene glycol monomethyl ether, ethylene glycol monoethyl ether, propylene glycol monobutyl ether and ethylene glycol monopropyl ether.

10. A cleaning solution according to claim 1 wherein said cleaning solution comprises 3-7 weight % of said co-solvent.

11. A cleaning solution according to claim 1 wherein said surfactant is one of non-ionic, anionic, cationic and amphoteric.

12. A cleaning solution according to claim 1 wherein said surfactant is nonylphenol ethoxylate, a phosphate ester, or a combination thereof.

13. A cleaning solution according to claim 1 wherein said cleaning solution has a viscosity of 3 centistokes or higher at 21 degrees C.

14. A method of removing a residual ink image from a transferring surface of a printing blanket used for printing with radiation-curable ink on an offset lithographic printing press, comprising in the following order the steps of:
(a) removing said blanket from said offset lithographic printing press;
(b) applying a thickened aqueous cleaning solution to said transferring surface of said blanket to form a layer thereon;
(c) permitting said layer of cleaning solution to remain in contact with said surface for a period of time;
(d) rubbing said surface of said blanket; and
(e) removing soiled cleaning solution from said surface.

15. A method according to claim 14 wherein said cleaning solution comprises an alkaline builder that comprises NaOH or KOH, an amine, a thickener, a co-solvent that comprises an alcohol or glycol ether, a surfactant and water.

16. A method according to claim 15 wherein said thickener is xanthan gum.

17. A method according to claim 15 wherein said surfactant is nonylphenol ethoxylate, a phosphate ester or a combination thereof.

18. A method according to claim 14 wherein said blanket comprises rubber.

19. A method according to claim 14 wherein said step of applying is done by means of a roller.

20. A method according to claim 14 wherein said step of applying is done by spraying.

21. A method according to claim 14 wherein said layer of cleaning solution is a thick, substantially uniform layer.

22. A method according to claim 14 wherein said period of time is 5-10 minutes.

23. A method according to claim 14 further comprising, after step (c), repeating steps (b) and (c).

24. A method according to claim 14 wherein said step of rubbing is done by means of rags or sponges.

25. A method according to claim 14 wherein said step of rubbing is done with mild abrasion of said surface.

26. A method according to claim 14 wherein said cleaning solution has a viscosity of 3 centistokes or higher at 21 degrees C.
